(19) United States
(12) Patent Application Publication
(10) Pub. No.: US 2013/0090963 A1
(43) Pub. Date: Apr. 11, 2013

(54) METHOD AND SYSTEM FOR OPTIMIZING DISPATCH WORKFLOW INFORMATION

(71) Applicants: Nityanand Sharma, Tampa, FL (US); Amit Shahani, Ellicott City, MD (US); Ramkishen Kalyana, Irving, TX (US)

(72) Inventors: Nityanand Sharma, Tampa, FL (US); Amit Shahani, Ellicott City, MD (US); Ramkishen Kalyana, Irving, TX (US)

(73) Assignee: VERIZON PATENT AND LICENSING INC., Basking Ridge, NJ (US)

(21) Appl. No.: 13/267,404

(22) Filed: Oct. 6, 2011

(51) Int. Cl. G06Q 10/06

(52) U.S. Cl. 705/7.13

(57) ABSTRACT

An approach for enabling a service provider to dispatch workforce for fulfilling a plurality of service requests based on a common property identifier is described. A workforce dispatch platform determines a property identifier associated with a customer based on a service request. A determination is then made as to whether the property identifier corresponds to one or more property identifiers corresponding to a plurality of other service requests. The workforce dispatch platform generates workflow information for dispatch of workforce to satisfy the request and the other requests based on the determination.

### BACKGROUND INFORMATION

Service providers are continually challenged to deliver value and convenience to consumers by providing compelling products and service offerings. Customers demand greater responsiveness and efficiency from service providers when it comes to fulfilling service requests. For example, when a customer's premise is equipped with various communications, network, and computing systems by the provider, various installation, upgrade, troubleshooting and ongoing maintenance tasks are required to be performed in order to maximize consumer value. Conversely, the service provider must ensure proper scheduling and dispatch of limited technicians, specialists, tools and other resources in order to meet deadlines, maximize efficiency and minimize costs.

As the demand for service requests by the customer grows, however, delays or inefficiencies in the provisioning of limited workforce resources may occur. This is especially prevalent in cases where redundancies in service requests surrounding a particular premise or within a given geographical region of the premise are not accounted for by the service provider when dispatching the workforce.

Based on the foregoing, there is a need for effective dispatching of a service provider workforce.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system for enabling a service provider to dispatch workforce for fulfilling multiple service requests based on a common property identifier, according to one embodiment;

FIG. 2 is a diagram of a workforce dispatch platform, according to one embodiment;

FIG. 3 is a ladder diagram showing a process for dispatching workforce for fulfilling multiple service requests based on a common customer premise, according to an exemplary embodiment;

FIGS. 4A and 4B are flowcharts of processes for enabling a service provider to fulfill multiple service requests based on a common customer premise, according to various embodiments;

FIGS. 5A-5C are diagrams of user interfaces for enabling a service provider to fulfill multiple service requests based on a common customer premise, according to one embodiment;

FIG. 6 is a diagram of a computer system that can be used to implement various exemplary embodiments; and

FIG. 7 is a diagram of a chip set that can be used to implement an embodiment of the invention.

### DESCRIPTION OF THE PREFERRED EMBODIMENT

An apparatus, method and software for enabling a service provider to dispatch workforce resources for fulfilling multiple service requests based on a common customer premise is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to customer service requests, it is contemplated that these embodiments have applicability to any data protocols, methodologies or systems for performing order fulfillment, resource allocation, fleet management, and the like.

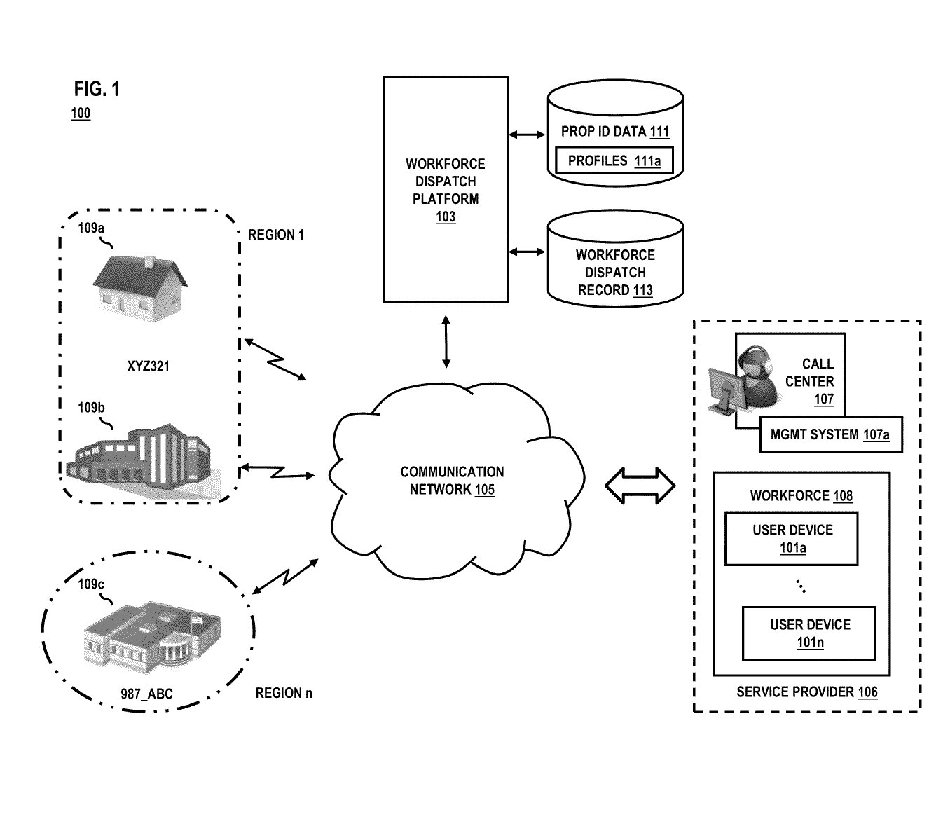

FIG. 1 is a diagram of a system for enabling a service provider to dispatch workforce for fulfilling multiple service requests based on a common property identifier, according to one embodiment. For the purposes of illustration, system 100 is described with respect to workforce management functions performed by a service provider (e.g., telecommunications service provider). As shown, system 100 can include one or more user devices 101a-101n (e.g., mobile device, smart phone, netbook, laptop or any computing device capable of interaction over a communication network 105, etc.). The user devices 101a-101n are utilized by various members of a workforce 108 of a service provider 106 and are configured to receive and share information pertaining to the fulfillment of one or more service requests. In certain embodiments, the workforce 108 of the service provider 106 may include one or more technicians, specialists, engineers, analysts, facilitators, operators, managers and other categories of workers employed by the service provider 106 to support a customer. Service requests made by the customer may include any tasks required for enabling, maintaining or enhancing a system or infrastructure implemented by the service provider 106 for use with respect to a premise of the customer. By way of example, a telecommunications service provider may employ a network of service technicians to support a communications system, comprising various software, hardware and firmware components, as implemented within or about a customer's office location. As another example, a media or television broadcast service provider may employ a network of independent contractors and installation specialists to configure set-top boxes, satellite equipment, broadband equipment and other equipment within or about a customer's residence.

Service requests include, for example, any request made by a customer requiring the expertise of the service provider 106. Generally, the requests are received from a customer by way of phone to a call center 107, which connects with or employs a management system 107a for managing one or more service requests, customer account details, workforce information of the service provider and other vital information for enabling customer service and support. A call center 107 analyst or other representative of the service provider 106 enters data as provided by the customer during the call to facilitate the handling of the service request. Alternatively, a user may submit a service request to the provider 106 by way of electronic means, such as by completing an electronic service request entry form (e.g., web form), sending an e-mail, initiating a chat session, etc.

Actions performed responsive to a service request may include installing, upgrading, troubleshooting and performing ongoing maintenance of systems, equipment and other features of a given product and/or service offering. Typically, customers who purchase products from the provider for use within or about their property, such as communication and networking products, expect quick and efficient responses to requests as delays and setbacks can significantly impact their operations, infrastructure and even the function of their premise, i.e., office location or residence. Likewise, the service provider 106 is cognizant of the short and long-term ramifications of poor fulfillment of service requests to their business and reputation. Thus, they are tasked with ensuring effective scheduling and dispatching of their workforce and associated resources for fulfilling the request, including the scheduling of tools, vehicles and specialized equipment, to meet deadlines and customer expectations. Workflow execution and planning, which includes for example the sequencing, coordinating, prioritizing, scheduling and assigning of tasks for meeting specific objectives, is critical to the overall operational performance of the service provider 108.

Unfortunately, traditional management systems maintained by service providers are not configured to account for redundancies in the scheduling and dispatching of their workforce and associated resources to the same building, community or geographic region. For example, a first technician dispatched to perform an installation at a residence in a certain community may be dispatched at or near the same time as a second technician assigned to a store in the same community. If a single technician were to be dispatched to this community by the service provider 108, geographic redundancies of this nature could be avoided to maximize efficiency and minimize costs. The lack of coordinated dispatch and resource allocation, however, by the service provider on the basis of known property characteristics or identity prevents this capability. In short, there are currently no convenient means for effectively managing dispatch and workflow requirements of a service provider based on key attributes of a premise associated with one or more service requests.

To address this issue, system 100 presents a workforce dispatch platform 103 for enabling the provisioning of a workforce 108 to fulfill service requests based on a common property identifier. A property identifier may include, for example, a unique, pre-assigned value as maintained by the service provider 106, i.e., via the platform 103, for identifying a specific building, house, community, geographic region, or the like. The level of granularity of the assigned property identifier may vary according to the preferences of the service provider 106. By way of example, properties 109a and 109b may both correspond to property identifier “XYZ123”, while another property 109c is assigned property identifier “987_ABC.” As shown in the figure, properties 109a-109b are located within a geographic region labeled REGION 1, while property 109c is located in REGION 2. It is noted that regional mapping and property identification assignments may be generated by the service provider 106 based on various factors at the provider's discretion, including workforce size and availability, equipment availability, customer size, scalability factors, etc. Also, property identifier data 111 (or property identifiers 111) may be linked with specific customer profile information 111a, i.e., account details and preferences, for associating one or more properties with a particular customer. As such, a single customer may have a multiple properties located throughout multiple regions, each of which is assigned a unique identifier.

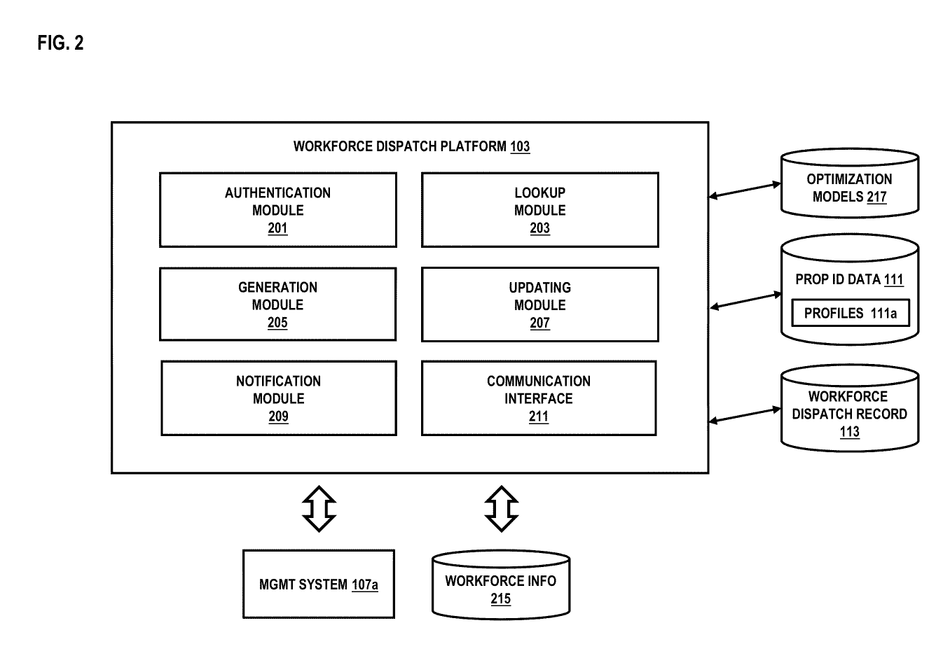

System 100 provides an approach for enabling generation of an optimized workforce dispatch record 113 for controlling the dispatch of a workforce 108 in response to received service requests from customers premise corresponding to properties 109a-109c. As noted, service requests may be submitted by way of telephone to a call center 107 that is maintained by or affiliated with the service provider 106 to handle customer calls. Alternatively, requests may be retrieved and processed by the provider 106 in digital form. A management system 107a may be implemented for use by the service provider 106 as a call center 107 management tool, customer relationship management tool, fleet management system, order requisition tool or combination thereof for facilitating service request processing and execution. In certain embodiments, the management system 107a may be a proprietary or third-party solution for providing representatives of the provider 106 (e.g., call center analysts) access to workforce information, customer profile information and other vital or sensitive data accordingly. As will be discussed more fully with respect to FIG. 2, the management system 107a may be employed in connection with the call center 107 and/or workforce dispatch platform 103 to enable the sharing of workflow information for fulfilling service requests based on one or more property identifiers 111. Workflow information may include scheduling information, workforce information, priority information, sequencing information or a combination of other necessary information for affecting the response of the workforce 108 to service requests.

In certain embodiments, the workforce dispatch platform 103 maintains workflow information within the workforce dispatch record 113. This includes, for example, scheduling information for indicating times and dates of service order/job execution, data for indicating the names and identifiers of various workforce 108 members to service a request, an order or sequence of execution of one or more service orders/jobs, etc. Service orders or jobs may include, for example, an assigned task and corresponding identifier to be associated with a given service request. It is noted that a service order or job, as referenced in a workforce dispatch record 113 and maintained by a management system 107a, represents a commitment of workforce 108, resources, time and/or money on the part of the service provider 106 in relation to a given request.

In addition, workforce information may also be maintained or accessed by the workforce dispatch platform 103. In certain embodiments, workforce information may indicate various historic or current characteristics, conditions or statistics regarding the workforce of the service provider 106. By way of example, this may include workforce 108 capacity and availability, resource availability (e.g., tools and equipment), inventory conditions, average service request fulfillment time data of individuals or groups within the workforce 108, workforce 108 experience and capability data, workforce-to-customer relationship data, service order/job fulfillment protocols, etc. The workforce information may pertain to any sensitive or proprietary information regarding the service provider 106 and its capabilities.

The above described workflow information, workforce information and other data (e.g., customer profile data) may be processed by the workforce dispatch platform 103 for generating an optimized version of the workforce dispatch record 113. The optimized record 113 is based on changing, updated or future service request needs associated with various property identifiers 111. Property identifier data 111 associated with respective properties 109a-109c or geographic regions thereof are also analyzed by the platform 103 in relation to received service requests to determine if one or more requests correspond to a single property identifier. By way of example, a first and second service order in the work dispatch record 113 for fulfilling a first and second request pertaining to properties 109a and 109b respectively may be linked to a single property identifier XYZ321. Consequently, the workforce dispatch platform 103 may rely on such information in addition to available workforce information for determining that a single workforce 108 member may be dispatched for handling both requests.

Hence, analysis and processing is facilitated based on workforce information (e.g., technician experience, equipment availability), current workflow information indicated in the dispatch record data (e.g., assigned service orders and dates), property identifier data (e.g., property location and region) and service request information (e.g., specific request type). One or more optimization models are used for generating the optimized result, wherein the models are designed based on one or more efficiency, maximization, resource usage, cost, scheduling, workflow or other factors of interest to the service provider 106. For example, a service efficiency maximization model may be utilized to associate a highly efficient application engineer with as many service requests for all property identifiers determined to occur within a given geographic region over a certain time period. As another example, a cost efficiency optimization model may be employed to determine the maximum number of man hour savings achieved by consolidating multiple service requests at a single multi-office building for execution by a single technician or over a restricted period of time (e.g., rescheduling dates set further to a date of the next scheduled service call). In yet another example, a relationship effectiveness optimization model may be applied against available data to determine which customer relations or sales engineer is experientially suited to address multiple training and installation issues corresponding to a set of property identifiers within range of another property identifier to which the workforce member is already associated. It is noted, therefore, that the optimization models employed for generating an updated workforce dispatch record 113 to affect workflow and/or associated resources may vary from one service provider to the next.

In one embodiment, the workforce dispatch platform 103 is offered by a service provider 106 as a managed or hosted solution. The platform 103 also enables any one of the user devices 101a-101n, as provided to the workforce 108, to receive updated workforce dispatch record data 113 or respond to service requests pursuant to an optimization. Given the logistical and functional constraints associated with the flow of human, material and technical resources throughout an organization, immediate or real-time execution of workflow information featured in the optimized record 113 may not be feasible. For example, a service request pertaining to a downed telephone line or transformer may require the use of a truck equipped with a crane, which may not be immediately available concurrent with receipt of the request. It is contemplated, however, that future embodiments of the system 100 may accommodate immediate provisioning of resources in association with a request regarding a given property identifier. Furthermore, the workforce dispatch platform 103 may be configured to account for one or more logistical considerations for affecting the immediacy of workflow adaptations in response to one or more service requests for a given property identifier, one or more other property identifiers, or a combination thereof.

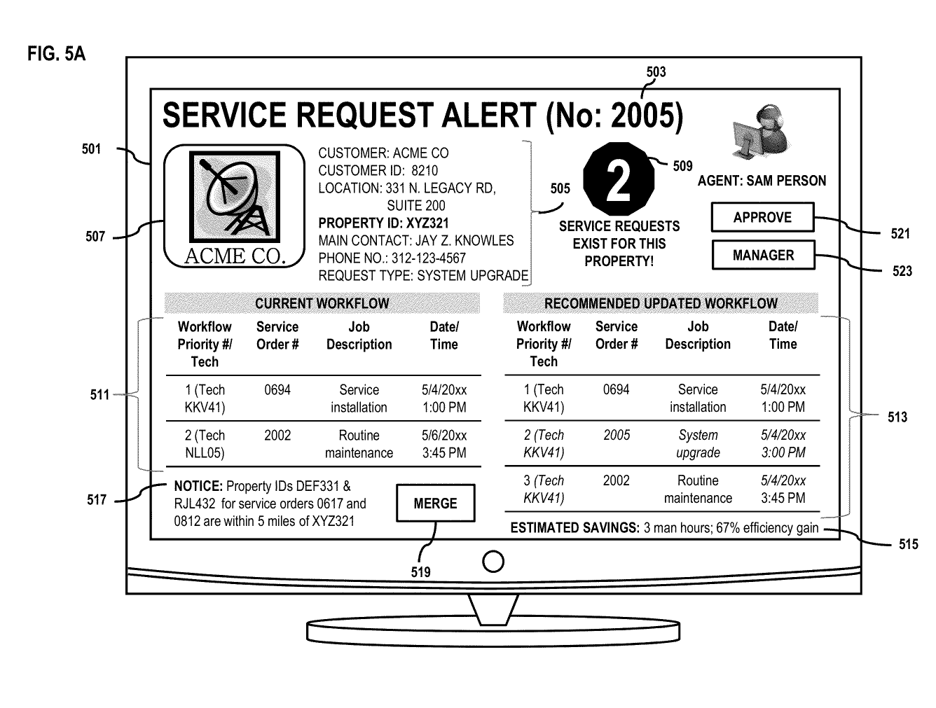

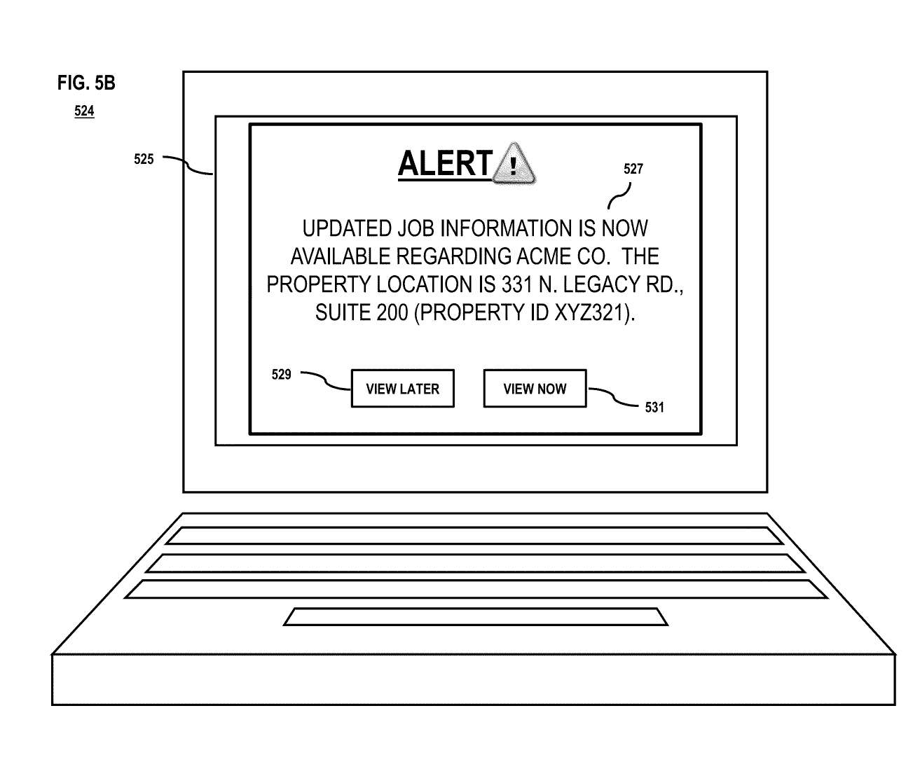

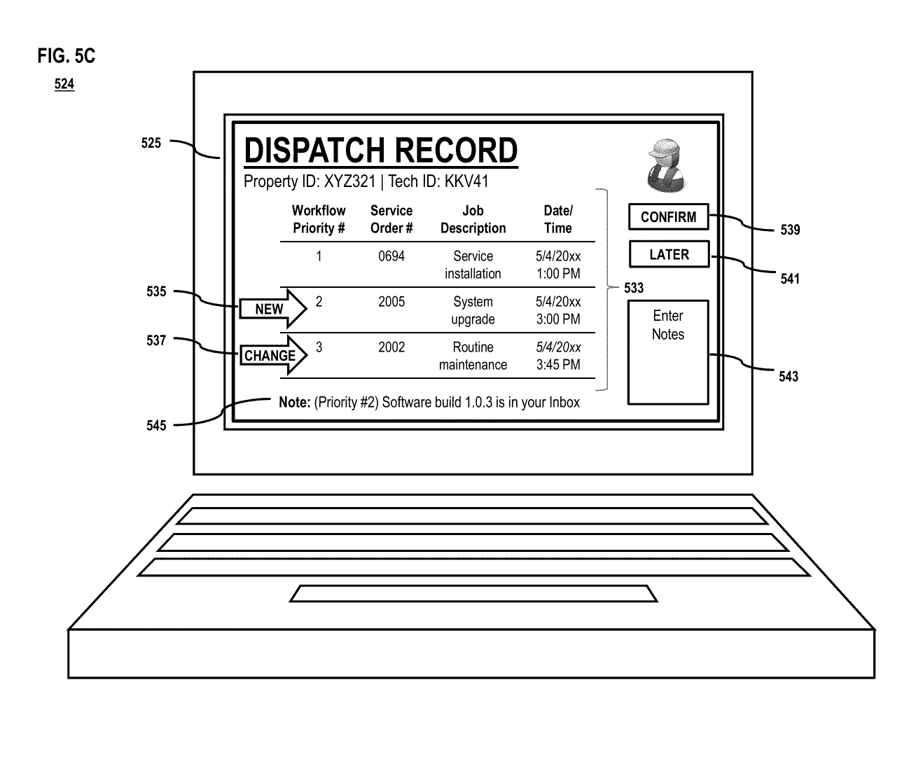

As discussed more fully with respect to FIGS. 5A-5C, the workforce dispatch platform 103 may at least be configured to (1) generate initial or updated workflow information for inclusion in a workforce dispatch record 113 based on a common property identifier 111; and (2) subsequently convey notifications regarding the workforce dispatch record data 113 to relevant members of the workforce 108 via their respective user devices 101a-101n.

It is noted that user devices 101a-101n may be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), Smartphone or any combination thereof. It is also contemplated that the user devices 101a-101n can support any type of interface for supporting the presentment or exchanging of data. In addition, user devices 101a-101n may facilitate various input means for receiving and generating information, including touch screen capability, keyboard and keypad data entry, voice-based input mechanisms and the like. Any known and future implementations of user devices 109 are applicable.

In various embodiments, network 105 may be any suitable wireline and/or wireless network, and be managed by one or more service providers. For example, network 105 may include an integrated services digital network (ISDN), public switched telephone network (PSTN) or other like network. In the case of a wireless network configuration, such networks may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. In addition, the communication network 105 may be support any local area network (LAN), metropolitan area network (MAN), wide area network (WAN), the Internet, or any other suitable packet-switched network, such as a commercially owned, proprietary packet-switched network, such as a proprietary cable or fiber-optic network.

It is further contemplated that the communication network 105 may include components and facilities to provide for signaling and/or bearer communications between the various components or facilities of system 100. In this manner, they may embody or include portions of a signaling system 7 (SS7) network, or other suitable infrastructure to support control and signaling functions. Various end user devices (not shown) may be utilized to communicate over system 100 and may include any customer premise equipment (CPE) capable of sending and/or receiving information over the network 105—i.e., for sending of service requests. By way of example, a voice terminal may be any suitable plain old telephone service (POTS) device, facsimile machine, etc., whereas a mobile device (or terminal) may be any cellular phone, radiophone, satellite phone, smart phone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

It is noted, though not shown in the figure, that in certain embodiments user devices 101a-101n may be configured to establish peer-to-peer communication sessions with each other using a variety of technologies—near field communication (NFC), Bluetooth, ZigBee, infrared, etc. Also, connectivity can be provided via a wireless local area network (LAN). By way of example, a group of user devices 101a-101n may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 101, i.e., IP addresses that are accessible to devices connected to the service provider network 106 as facilitated via a router.

The various components of the workforce dispatch platform 103 are now presented. FIG. 2 is a diagram of a workforce dispatch platform, according to one embodiment. The workforce dispatch platform 103 includes various executable modules for performing one or more computing, data processing and network based instructions that in combination provide a means of generating scheduling information for dispatch of workforce based on whether a request corresponds to the one or more property identifiers. Such modules can be implemented in hardware, firmware, software, or a combination thereof. By way of example, the platform 103 may include an authentication module 201, a lookup module 203, a generation module 205, an updating module 207, a notification module 209 and a communication interface module 211.

In addition, the platform 103 also accesses one or more optimization models 217, property identifier data 111 and profile information 111a and workforce dispatch record data 113. This data may be obtained from, or in connection with, a management system 107a as maintained by the service provider. Workforce information 215 may also be accessed by the workforce dispatch platform 103, i.e., by way of communication with the management system 107a, to enable processing. It is noted that data 111, 111a and 113 may provide necessary input data for enabling optimization and analysis to be performed via the models 217 for increasing service request execution, including scheduling information (e.g., time, date, time range, date range), workforce information, priority information (e.g., job priority), sequencing information (e.g., order of scheduled execution), or a combination thereof.

In one embodiment, an authentication module 201 receives service requests via e-mail, short messaging service, electronic service request file, or any other electronic input means. Alternatively, the authentication module 201 receives service request input, such as provided by a call center analyst or other representative of the service provider. Based on the received input, including for example a customer name, property address, account identifier, a customer identifier, phone number, e-mail address, or other data, the authentication module 201 determines if existing profile data 111a exists with respect to the customer. For example, in the case of a first time service request, an additional registration and profile configuration process may be facilitated. When a profile 111a related to the requesting customer is found, however, the authentication module 201 passes the input data to the lookup module 203.

In certain embodiments, the lookup module 203 determines a unique property identifier that is associated with a customer that submitted the service request as received via the authentication module 201. By way of example, when a profile 111a is retrieved for a customer, a reference to the one or more property identifiers 111 for the same customer is also identified. The lookup module 203 performs a crosscheck analysis of the profiles 111a and associated property identifier data 111 to determine whether the property identifier pertaining to the received service request corresponds to one or more property identifiers corresponding to a plurality of other service requests. Under this approach, the lookup module 203 determines whether there are multiple or redundant service request matches for a single property identifier. It is noted that in certain instances, when the customer provides a property identifier, the lookup module 203 need not perform the analysis, but rather, the user need only be validated by the authentication module. It is noted the lookup module 203 may facilitate the lookup based on one or more input variables, such as the customer name or a profile data 111a record identifier. Furthermore, the lookup module 203 may execute subsequent to, or concurrent with, execution of the authentication module 201 for enabling retrieval of a property identifier 111.

In certain embodiments, the generation module 205 generates workflow information for enabling dispatch of workforce to satisfy a received service request and other service requests related to the same property identifier. The workflow information is generated based at least in part, on the processing of data regarding the customer, workforce, service request, other service requests related by way of common property identifier, etc., via one or more optimization models 217. The workforce information generated by the generation module 205 for affecting workforce dispatch may include, for example, scheduling information such as time, date, and time and date range data. In addition, the workflow information may include workforce information such as technician name and identifier, job/service order priority information, job/service order sequencing information, or a combination thereof. By way of example, optimization variables may include intrinsic data relative to the workforce such as workforce capacity and availability, resource availability (e.g., tools and equipment), customer deadlines, average fulfillment time data, technician experience and capability data, customer relationship and preference data, etc. Extrinsic data may also be processed for generating optimized workflow information, including weather conditions, traffic data, building record data, etc.

The generation module 205 may execute, based on the models 217, various algorithms for establishing a workflow priority or sequencing of one or more service requests associated with a common property identifier based on an average time of completion of particular jobs by a technician. As another example, office location information for a property may be processed to optimize the order of execution of a service request relative to the optimal intra-building walk route of the technician; the optimized result being reduced walk time while maximizing overall service request fulfillment time. Operating in connection with a communication interface and user interface module, the generation module may facilitate presentment of metrics and other data for indicating the effective gains, losses or other effects of a determined optimization.

It is noted that the generation module 205 may generate optimized workflow information without affecting the current workforce dispatch record 113. By way of example, the optimized workflow information may include the assigning of a different workflow priority, different workforce information, different scheduling information, or a combination thereof that is currently maintained in the workforce dispatch record 113. Hence, the generation or updating of the workforce dispatch record 113 based on the optimized workflow information (or initial workflow information) is regulated and performed by an updating module 207.

In certain embodiments, the updating module 207 stores the workflow information to the dispatch record 113 along with a reference to the property identifier for which the optimized workflow information was generated. Hence, updating of the workflow information for affecting dispatch of workforce occurs in response to a determined affinity between a property identifier relating to one or more service requests. Also, the updating module 207 may be configured to carryout the generation of updating of the workforce dispatch record 113 based on one or more writing, overwriting or data approval procedures designated by the service provider. For example, the update may occur automatically or be staged for manual approval and execution depending on security and permission settings of the management system 107a. In the later case, an update to the workforce dispatch record 113 can only occur based on the approval of a manager or other representative of the service provider.

In one embodiment the notification module 209 generates a notification message regarding an updated or generated workforce dispatch record 113. The notification module 209 also operates in connection with a communication interface 211 to cause transmission of the notification message to the various workforce members affected by updated workforce dispatch record data—i.e., a newly assigned or previously assigned service technician, a manager of the one or more service technicians, etc. In addition, the notification module 209 can be transmitted to the management system 107a for review by a call center analyst or other representative of the service provider. Still further, the notification message may generated for transmission to a customer user device, i.e., for responding to a service request. By way of example, the notification module 209 generates notification conforming to application programming interfaces (APIs) or other function calls of receiving user devices 101a-101n, a user interface of the management system 107a, a customer user device, etc., thus enabling the display of graphics primitives for representing workflow information, service request fulfillment status and other details.

In one embodiment, a communication interface 211 enables formation of a session over a network 105 between the workforce dispatch platform 103 and the user devices 101a-101n or management system 107a. By way of example, the communication module 211 executes various protocols and data sharing techniques for enabling collaborative execution between a workforce member's user devices 101a-101n (e.g., mobile devices, laptops, smartphones, tablet computers, desktop computers) and the workforce dispatch platform 103 over the network 105.

It is noted that the authentication process performed by the module 201 may also include receiving and validating a login name and/or user identification value as provided or established for a call analyst or other representative accessing the workforce dispatch platform 103. This may coincide with a subscription or registration process, or alternatively, an integration process of the workforce dispatch platform 103 with the management system 107a. By way of example, the above presented modules and components of the platform 103 can be implemented in hardware, firmware, software, or a combination thereof. Though depicted as a separate entity in FIG. 1, it is contemplated that the platform 103 may be implemented for direct operation by the management system 107a. As such, the workforce dispatch platform 103 may generate direct signal inputs by way of the operating system of the management system 107a communicating with devices 109a-109n.

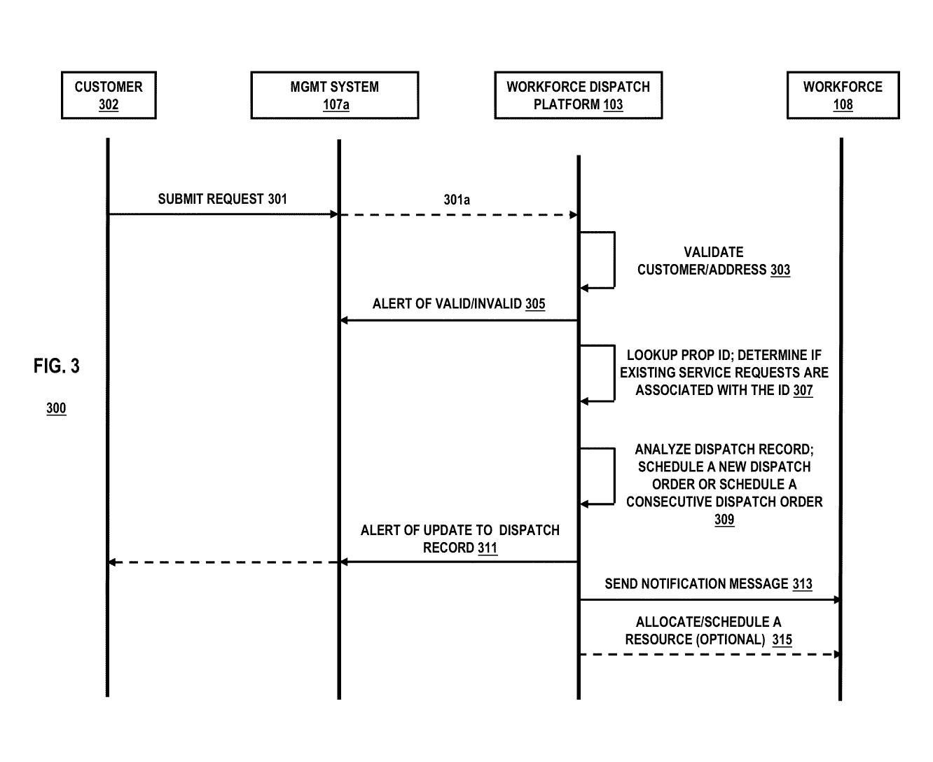

FIG. 3 is a ladder diagram showing a process for dispatching workforce resources for fulfilling multiple service requests based on a common customer premise, according to an exemplary embodiment. By way of example, the diagram depicts an interaction process 300 between the customer device (or system) 302, management system 107a, workforce dispatch platform 103 and the workforce 108. In step 301, the customer device 302 submits a service request to the service provider in response to a particular service need. The service need may require specific tasks to be performed by the service provider, including an installation, upgrade, troubleshoot, enhancement, etc. Submission of the service request is performed by way of telephone or through electronic means, with the request being managed by the service provider via a management system 107a. Depending on the extent of integration of the management system 107a and workforce dispatch platform 103, the service request may be transmitted to the workforce dispatch platform 103 directly or by the management system 107a per step 301a.

In steps 303 and 305 respectively, the workforce dispatch platform 103 validates the customer and/or associated property address, then sends an alert of validity or invalidity to the management system in response to the validation process. In step 307, the workforce dispatch platform 103 also looks up the corresponding property identifier of the customer premise associated with the service request. This may include cross checking of the property identifier against customer profile or workforce dispatch records to determine if any existing service requests are already associated with the determined property identifier. Per step 309, the workforce dispatch platform 103 then analyzes the workforce dispatch record, workforce information, profile data and associated property identifier using one or more optimization models, the service request and the one or more other service requests related to the same property identifier to generate optimized workflow information. The optimization includes generation of data for scheduling and sequencing the one or more service requests for fulfillment as a new workforce dispatch order or that for scheduling and sequencing consecutive service requests to be fulfilled (e.g., back-to-back workflow prioritization for job fulfillment).

The management system 107a is notified of the generation and/or updating of the workflow dispatch record along with the customer, corresponding to step 311 and 311a. In addition, a notification message is sent to the various members of the workforce who are specified as being assigned to various of the service requests in the workforce dispatch record. This may include, for example, a technician assigned to perform an install, a manager, or other representative of the service provider that is to engage in fulfillment of the service request associated with a specific property identifier. The notification messages may be sent to the user devices of the workforce based on known workforce information, such as a contact number, e-mail address, etc.

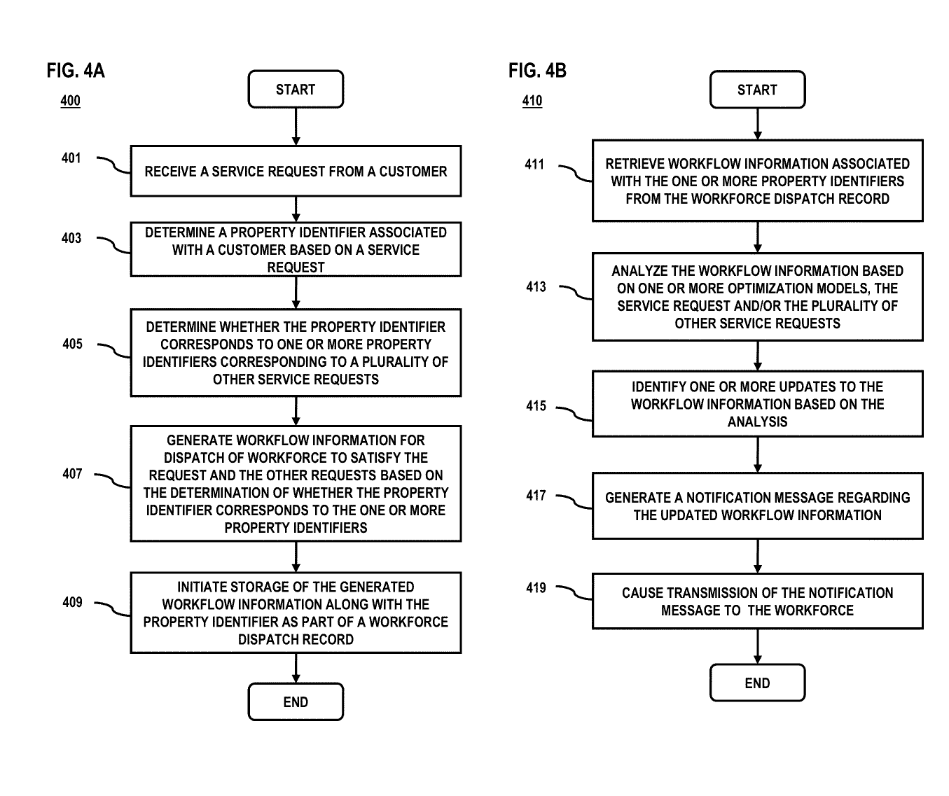

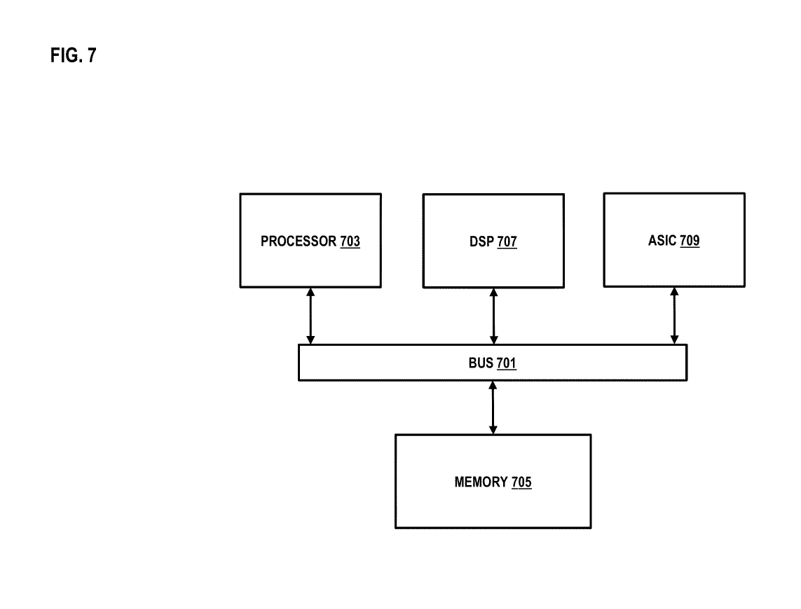

FIGS. 4A and 4B are flowcharts of processes for enabling a service provider to fulfill multiple service requests based on a common customer premise, according to various embodiments. In one embodiment, the workforce dispatch platform 103 performs processes 400 and 410 and is implemented in, for instance, a chip set including a processor and a memory as shown in FIG. 7. It is noted that the steps of the process may be performed in any suitable order, as well as combined or separated in any suitable manner.

In step 401 of process 400, the management system 107a and/or workforce dispatch platform 103 receives a service request from a customer. As mentioned, the service request may include the sharing of data for indicating the type of service required to be performed by the service provider, a requested date, date range or deadline of completion for the service, a customer identifier and name, property location, etc. In a next step 403, the workforce dispatch platform 103 determines a property identifier associated with the customer based on a service request. In another step 405, the platform 103 determines whether the property identifier corresponds to one or more property identifiers corresponding to a plurality of other service requests. This process enables multiple instances of service requests associated with the same property identifier to be identified.

In another step 407, the workforce dispatch platform 103 generates workflow information for providing dispatch of the service provider workforce to satisfy the request and any other requests based on the determination of whether the property identifier corresponds to the one or more property identifiers. As mentioned, workflow information is generated by way of one or more optimization models, which may include various schemas and associated algorithms for processing one or more input variables. Inputs received for processing against the one or more optimization models may include, for example, workforce information, customer profile information, property identifier data, service request information, various data maintained in a current workforce dispatch record 113, or a combination thereof.

Per step 409, the workforce dispatch platform 103 initiates storage of the generated workflow information along with the property identifier as part of a workforce dispatch record. As mentioned previously, the workflow information may include one or more data related to the sequencing, prioritization and scheduling (e.g., time, date) of a service order as arranged to fulfill a service request related to the one or more (common) property identifiers. In addition, the workflow information may include one or more instructions for fulfillment of the service request along with assigned workforce for handling the request. It is noted, therefore, that the workflow information as generated based at least in part on the property identifier may be suited for affecting the execution of jobs/orders by the service provider respective to that identifier. Furthermore, the workflow information may be used to enable formation of an initial workforce dispatch record 113 or for updating a current workforce dispatch record 113.

FIG. 4B depicts the various processes for affecting generation and sharing of workflow information as maintained via a workforce dispatch record 113. As noted before, the workforce dispatch record 113 is a file, log, document, or other set of information maintained by the service provider for communicating the execution of service orders responsive to customer requests. In step 411 of process 410, the workforce dispatch platform 103 retrieves workflow information associated with the one or more property identifiers. The platform 103 also analyzes the workflow information based on one or more optimization models, the service request, the multitude of other service requests, or a combination thereof. With respect to the service request, for example, details regarding the type of task to be performed may be used for prioritizing or sequencing the execution of service orders, i.e., by way of a service order/job escalation scheme. Per step 415, the workforce dispatch platform 103 identifies one or more updates to the workflow information based on the analysis. In certain cases, for instance, when several service orders are associated with a single property identifier, the workflow information may include the scheduling, rescheduling, or discontinuing of certain orders given the need of the customer, the impact to the service provider and its workforce, the resource requirements for fulfilling the service requests and other factors. As noted previously, the updated or newly generated workflow information may be stored to the workforce dispatch record or presented for review and subsequent acceptance.

In steps 417 and 419, the workforce dispatch platform 103 generates a notification message regarding the updated workflow information and causes transmission of the notification message to the workforce respectively. Generally, the notification message may indicate the updating of the workforce dispatch record 113 based on the workflow information as generated. Furthermore, the notification message may reference service orders to be executed at a future date or time, such as to enable sufficient time for procuring the resources necessary for servicing the one or more properties. By way of example, the notification message may include a list of all service orders/jobs to be performed by workforce group or team for next week in relation to one or more property identifiers. In certain embodiments, it is contemplated that the workforce dispatch record may also be associated with incentive information, including for example, metrics for representing gains achieved by the service provider, incentives for the workforce based on service order/job execution goals, etc.

FIGS. 5A-5C are diagrams of user interfaces for enabling a service provider to fulfill multiple service requests based on a common customer premise, according to one embodiment. For the purpose of illustration, the diagrams are described with respect to an exemplary use case of the workforce dispatch platform 103 interacting with a call center analyst associated with the service provider and a technician of the service provider. It is noted that while the user interface depictions correspond to the process of notification and presentment of workflow information via a workforce dispatch record 113, respective devices for receiving the information may be configured to cause presentment of various additional screens.

In FIG. 5A, a service request alert notification is presented to a display 501 of a user device of a call center agent or other representative of the service provider. The notification is presented by way of a management system 107a of the call center 107 in conjunction with the workforce dispatch platform 103. By way of example, the interface 501 is presented in response to the receipt of an electronic service request as generated by the customer (e.g., via an electronic order form, web form, e-mail). Upon submission, a service order number 503 is generated respective to the request, which in this example corresponds to service order/job number 2005.

The service alert notification also features various fields for displaying pertinent information to the representative, i.e., agent Sam Person who is currently logged into the management system 107a and/or workforce dispatch platform 103. For example, profile information 505 regarding the customer is presented such as an icon 507 representative of the customer, the customer name, a customer identifier, location information, a property identifier, customer contact information and the specific service request type. As mentioned previously, the property identifier data for the specified customer is determined by the workforce dispatch platform 103 based on the property location, the customer identifier, the provided phone number, etc. It is noted that, in certain instances, the user may directly specify a property identifier related to their premise at the time of generating the service request if they have access to such information.

The workforce dispatch platform 103 performs a check to determine if any existing service requests correspond to the property identifier XYZ321 as assigned to the location of the customer premise. A determination may also be performed to identify if other service requests are scheduled for performance within a predetermined range of property identifier XYZ321. Under this scenario, two existing service orders—i.e., having assigned service order numbers 0694 and 2002 are already determined for execution within the workforce dispatch record relative to the same property identifier. Consequently, the display 501 is caused to present an icon 509 for indicating that two service orders associated with the property identifier are common to the newly received service request (service order number 2005).

An analysis and optimization process is then carried out based on the commonality between the various service orders 0694, 2002 and 2005; the results being subsequently presented to the display accordingly for review or approval. As noted, optimization models are applied for affecting the current workflow information, i.e., priority and scheduling of service orders. By way of example, current workflow information 511 is shown along with recommended updated workflow information 513 pursuant to the optimization analysis. In the current workflow information 511, service orders 0694 and 2002 are shown to be performed by different technicians KKV41 and NLL05 respectively. Furthermore, jobs corresponding to the service orders are scheduled for different dates according to the current (pre-optimized) workflow information 511. As a result of the optimization and analysis, however, the recommended workflow information 513 includes all three service orders 0694, 2002 and newly added 2005. The newly added service order 2005 is scheduled for 3:00 PM on the same day as existing service order 0694 that was already assigned to technician KKV41; service order 2005 being assigned a secondary workflow priority number to indicate its execution by the technician for after completion of service order 0694. In addition, service order 2002 is reassigned to technician KKV41 from technician NLL05 pursuant to the optimization analysis.

By way of example, the analysis may be based on factors such as the timing information (e.g., time and date), an average or recommended length of time to perform a system upgrade per service order 2005, the availability of the technician(s), a technician preference as indicated by the client, an up-selling opportunity, relationship criteria of the technician, experiential data regarding the technician, a computed maximum cost and efficiency savings and other like factors. Metrics 515 for notifying the agent of a computed gain in efficiency, maximization, utilization, cost, scheduling, workflow or other factor may also be presented.

The service request notification also includes a notice section 517 for indicating that one or more other property identifiers corresponding to one or more other service orders are within a predetermined range of the property identifier (XYZ321) subject to the service request for service order 2005. Under this scenario, the call center analyst can select a “MERGE” action button 519 to enable viewing of workflow information pursuant to a consolidation optimization, wherein one or more of the identified other property identifiers are scheduled for servicing by the same technician KKV41 as for service order 2005. Other action buttons also include a “APPROVE” action button 521 for enabling the agent to approve the recommended updated workflow information 513 and a “MANAGER” action button 523 for requesting approval by an authorized manager. It is noted, however, that action buttons 521 and 523 may be disabled or not featured for display when the workforce dispatch platform 103 is allowed to automatically update the workforce dispatch record 113 based on the optimized workflow information 513.

In FIGS. 5B and 5C, notification messages are presented to the display of a computing device 524 of technician KKV41 pursuant to the updated workflow information 513 of FIG. 5A. The notification message 507 indicates that updated workflow information is available and stored to the workforce dispatch record 113. Details specific to the technician are also presented, including the name of the company, the location of the property affected by the change and the corresponding property identifier to which the change is related. A “VIEW LATER” action button may be selected by the technician to delay viewing of the updated workflow information as captured in the record 113, while a “VIEW NOW” action button enables display of the updated workflow information as depicted in FIG. 5C.

In FIG. 5C, the updated workflow information 533 for property ID XYZ321 as reflected in the workflow dispatch record 113 is shown to include newly added service order 2005 and changed service order 2002 (e.g., date change). Icons 535 and 537 are presented to the display 525 for highlighting the new addition and change respectively. The technician can confirm receipt of the update by selecting a “CONFIRM” action button 539, opt to confirm later by selecting a “LATER” action button 541, or various notes into a note section 543 regarding the record 113. Also presented is a notice section 545 for indicating that one or more resources are available, scheduled or requested pursuant to the optimization for enabling fulfillment of a service order in connection with property identifier XYZ321. In this scenario, the resource is a data file pertaining to a software build for enabling execution of the system upgrade of service order 2005.

The exemplary techniques and systems presented herein enable effective generation of workflow information responsive to the determination of one or more property identifiers being associated with a received service order. Optimization models may be employed by a workforce dispatch platform 103 at the discretion of a service provider for producing a workflow result that conforms to the efficiency needs of the service provider while ensuring maximum effectiveness in responding to and fulfilling customer service requests.

The processes described herein for enabling a service provider to dispatch workforce for fulfilling multiple service requests based on a common property identifier may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

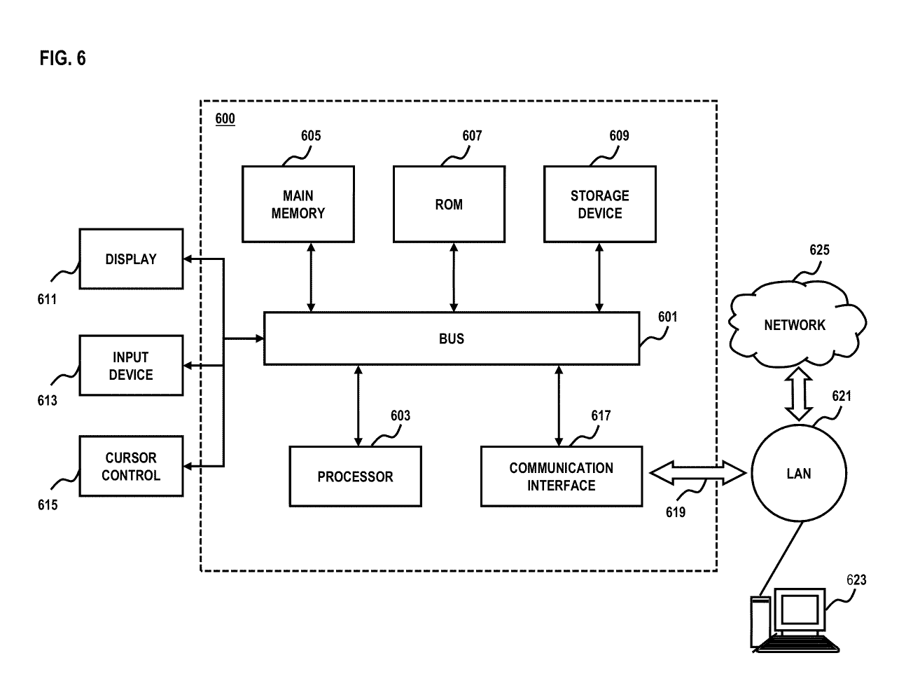

FIG. 6 is a diagram of a computer system that can be used to implement various exemplary embodiments. The computer system 600 includes a bus 601 or other communication mechanism for communicating information and one or more processors (of which one is shown) 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for adjusting cursor movement on the display 611.

According to an embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. Thus, embodiments of the invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIGS. 5A-5C, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the invention through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 7 illustrates a chip set or chip 700 upon which an embodiment of the invention may be implemented. Chip set 700 is programmed to enable a service provider to dispatch workforce for fulfilling multiple service requests based on a common customer premise as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of enabling a service provider to dispatch workforce for fulfilling multiple service requests based on a common customer premise.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to enable a service provider to dispatch workforce for fulfilling multiple service requests based on a common customer premise. The memory 705 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

1. A method comprising:
determining a property identifier associated with a customer based on a service request, the property identifier being pre-assigned according to a geographical region including a premise of the customer and to property management of the premise;
determining whether the property identifier corresponds to one or more property identifiers corresponding to a plurality of other service requests; and
generating workflow information for dispatch of workforce to satisfy the request and the other requests based on the determination of whether the property identifier corresponds to the one or more property identifiers.

2. A method according to claim 1, further comprising:
receiving a service request initiated by a customer; and
initiating storage of the generated workflow information along with the property identifier as part of a workforce dispatch record.

3. A method according to claim 1, wherein the workflow information includes scheduling information, workforce information, priority information, sequencing information, or a combination thereof.

4. A method according to claim 1, wherein the step of generating further comprises:
retrieving workflow information associated with the one or more property identifiers from a workforce dispatch record;
analyzing the workflow information based on one or more optimization models, the service request, the plurality of other service requests, or a combination thereof; and
identifying one or more updates to the workflow information based on the analysis.

5. A method according to claim 4, wherein the scheduling information includes a date, a time, a time range, a date range, or a combination thereof.

6. A method according to claim 4, wherein the workforce information includes contact information for the workforce, a workforce identifier, information regarding one or more resource associated with the workforce, one or more characteristics of the workforce, or a combination thereof.

7. A method according to claim 4, wherein the one or more optimization models are based on efficiency, maximization, utilization, cost, scheduling, workflow, or a combination thereof of factors associated with the workforce, the customer, the one or more property identifiers, or a combination thereof.

8. A method according to claim 1, further comprising:
generating a notification message regarding the updated workflow information; and
causing transmission of the notification message to the workforce.

9. An apparatus comprising:
at least one processor; and
at least one memory including computer program code for one or more programs, the at least one memory and the computer program code configured to, with the at least one processor, cause the apparatus to perform at least the following,
determine a property identifier associated with a customer based on a service request, the property identifier being pre-assigned according to a geographical region including a premise of the customer and to property management of the premise,
determine whether the property identifier corresponds to one or more property identifiers corresponding to a plurality of other service requests, and
generate workflow information for dispatch of workforce to satisfy the request and the other requests based on the determination of whether the property identifier corresponds to the one or more property identifiers.

10. An apparatus according to claim 9, wherein the apparatus is further caused to:
receive a service request initiated by a customer; and
initiate storage of the generated workflow information along with the property identifier as part of a workforce dispatch record.

11. An apparatus according to claim 9, wherein the workflow information includes scheduling information, workforce information, priority information, sequencing information, or a combination thereof.

12. An apparatus according to claim 9, wherein the step of generating further comprises:
retrieve workflow information associated with the one or more property identifiers from a workforce dispatch record;
analyze the workflow information based on one or more optimization models, the service request, the plurality of other service requests, or a combination thereof; and
identify one or more updates to the workflow information based on the analysis.

13. An apparatus according to claim 12, wherein the scheduling information includes a date, a time, a time range, a date range, or a combination thereof.

14. An apparatus according to claim 12, wherein the workforce information includes contact information for the workforce, a workforce identifier, information regarding one or more resource associated with the workforce, one or more characteristics of the workforce, or a combination thereof.

15. An apparatus according to claim 12, wherein the one or more optimization models are based on efficiency, maximization, utilization, cost, scheduling, workflow, or a combination thereof of factors associated with the workforce, the customer, the one or more property identifiers, or a combination thereof.

16. An apparatus according to claim 9, wherein the apparatus is further caused to:
generate a notification message regarding the updated workflow information; and
cause transmission of the notification message to the workforce.

17. A system comprising:
a workforce dispatch platform configured to determine a property identifier associated with a customer based on a service request, the property identifier being pre-assigned according to a geographical region including a premise of the customer and to property management of the premise,
wherein the platform is further configured to determine whether the property identifier corresponds to one or more property identifiers corresponding to a plurality of other service requests, and to generate workflow information for dispatch of workforce to satisfy the request and the other requests based on the determination of whether the property identifier corresponds to the one or more property identifiers.

18. A system according to claim 17, wherein the service request is initiated by a customer, the system further comprising:
a database configured to store the generated workflow information along with the property identifier as part of a workforce dispatch record.

19. A system according to claim 17, wherein the workflow information includes scheduling information, workforce information, priority information, sequencing information, or a combination thereof.

20. A system according to claim 17, wherein the platform is further configured to retrieve workflow information associated with the one or more property identifiers from a workforce dispatch record stored in the database, and to analyze the workflow information based on one or more optimization models, the service request, the plurality of other service requests, or a combination thereof,
wherein the platform is further configured to identify one or more updates to the workflow information based on the analysis.
